(19) United States
(12) Patent Application Publication
(10) Pub. No.: US 2023/0093894 A1
(43) Pub. Date: Mar. 30, 2023

(54) Corrugated Cardboard Pest Repellent System

(71) Applicant: EarthKind, LLC, Mooresville, NC (US)

(72) Inventors: Kari G. Warberg Block, Mooresville, NC (US); James E. McNew, Mooresville, NC (US)

(73) Assignee: EarthKind, LLC

(21) Appl. No.: 17/490,873

(22) Filed: Sep. 30, 2021

(51) Int. Cl. A01M 29/12; B31F 1/28

(52) U.S. Cl. CPC A01M 29/12; B31F 1/2804; B31F 1/2822; B31F 1/2872; B31F 2201/0787

(57) ABSTRACT

A corrugated cardboard pest repellent system for repelling and/or exterminating various pests around, within, or between layers of a corrugated cardboard construct while reducing the risk of contamination of goods or exposure by handlers. The corrugated cardboard pest repellent system generally includes one or more liners secured by an adhesive to one or more layers of a corrugated medium that has been treated by a pest repellent. The pest repellent is positioned on the underside of each crest of the one or more layers of the corrugated medium to prevent incursion of pests into the corrugated medium. Multiple layers may be stacked to form various constructs including a single face corrugated cardboard construct, a single wall corrugated cardboard construct, a double wall corrugated cardboard construct, and a triple wall corrugated cardboard construct. The resulting constructs may be utilized for various purposes, including forming various types of containers, padding, or liners.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The described example embodiments in general relate to a corrugated cardboard pest repellent system utilizing the space between layers of a corrugated cardboard construct for repelling and/or exterminating various pests while reducing the risk of contamination of goods or exposure by handlers.

Corrugated cardboard materials have become ubiquitous in shipping of a wide range of items. Such corrugated cardboard materials are used to form a number of different types of constructs that may be utilized for a wide range of purposes, such as for enclosing or protecting items being shipped.

By way of example, corrugated cardboard may be utilized to form a flexible, single-faced construct that may be utilized for a wide range of purposes, such as but not limited to use as a flexible protective wrap. Such single-faced constructs typically include a corrugated medium secured on one side to a liner (e.g., cardboard liner). As a further example, a double-faced construct may be formed by securing the second side of the corrugated medium to a second liner for purposes such as use as slip sheets or blanks for corrugated carton manufacturing.

Additional layers of medium may be applied as-needed to increase the thickness of the corrugated cardboard construct to suit different applications. For example, a double wall corrugated construct may be formed with two layers of medium sandwiched between three adjacent liners. As a further example, a triple wall corrugated construct may be formed with three layers of medium sandwiched between four adjacent liners.

While such corrugated cardboard constructs have been useful in packaging and shipping for many years, pests have been known to be drawn to corrugated packaging materials and into the dark, hidden spaces between the liners or within the mediums, and negatively impact the packaged contents, on or within the corrugated construct. Such pests can present a number of risks and undesirable situations due to such incursions within or between the layers of such corrugated cardboard constructs.

Various pests have been known to lay eggs within the corrugated cardboard constructs, thus exacerbating the problem. Additionally, when foods are being shipped, such pests can contaminate the foods. Various other items such as paper goods or plant materials may also be eaten by the pests. Finally, such pests have been known to defecate within the corrugated cardboard constructs, which can present serious health problems for any who handle the constructs at a later time.

While pest repellent treatments have been applied to various containers and liners, the regulation of such pest repellent treatments is highly regulated due to the toxic nature of many common repellents. It would be desirable to utilize corrugated cardboard constructs which repel such pests without any risk (or with a substantially lessened risk) of the repellent contaminating nearby goods or individuals who handle the corrugated cardboard constructs.

### SUMMARY

Some of the various embodiments of the present disclosure relate to a corrugated cardboard pest repellent system that can repel and/or exterminate various pests within or between layers of a corrugated cardboard construct while reducing the risk of contamination of goods or exposure by handlers. Some of the various embodiments of the present disclosure include a first liner secured to a first corrugated medium to form a single face construct, with the first corrugated medium being treated by a pest repellent. In some embodiments, a second liner may be secured to the first corrugated medium to form a single wall construct. In some other embodiments, a second corrugated medium that has been treated by the pest repellent may be secured between the second liner and a third liner to form a double wall construct. In some other embodiments, a third corrugated medium that has been treated by the pest repellent may be secured between the third liner and a fourth liner to form a triple wall construct.

There has thus been outlined, rather broadly, some of the embodiments of the present disclosure in order that the detailed description thereof may be better understood, and in order that the present contribution to the art may be better appreciated. There are additional embodiments of that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different FIGS. use identical reference numbers, the elements are generally either identical or at least similar in function or purpose.

### BRIEF DESCRIPTION OF THE DRAWINGS

FIG. 1 is a side sectional view of an assembly machine of a corrugated cardboard pest repellent system in accordance with an example embodiment.

FIG. 2 is a side view of an assembly machine of a corrugated cardboard pest repellent system in accordance with an example embodiment.

FIG. 3 is an exploded perspective view of a single face construct of a corrugated cardboard pest repellent system in accordance with an example embodiment.

FIG. 4 is an exploded perspective view of a single wall construct of a corrugated cardboard pest repellent system in accordance with an example embodiment.

FIG. 5 is an exploded perspective view of a double wall construct of a corrugated cardboard pest repellent system in accordance with an example embodiment.

FIG. 6 is an exploded perspective view of a triple wall construct of a corrugated cardboard pest repellent system in accordance with an example embodiment.

FIG. 7 is an end view of a medium and a liner aligned for assembly of a corrugated cardboard pest repellent system in accordance with an example embodiment.

FIG. 8A is a block diagram illustrating application of an adhesive to a liner of a corrugated cardboard pest repellent system in accordance with an example embodiment.

FIG. 8B is a block diagram illustrating application of a repellent to a medium of a corrugated cardboard pest repellent system in accordance with an example embodiment.

FIG. 8C is a partial end view of a repellent-treated medium secured to a liner of a corrugated cardboard pest repellent system in accordance with an example embodiment.

FIG. 9 is a block diagram of a corrugated cardboard pest repellent system in accordance with an example embodiment.

FIG. 10 is a flowchart illustrating assembly of a construct of a corrugated cardboard pest repellent system in accordance with an example embodiment.

FIG. 11 is a flowchart illustrating assembly of a construct of a corrugated cardboard pest repellent system in accordance with an example embodiment.

FIG. 12 is a flowchart illustrating assembly of a double-faced, single layer construct of a corrugated cardboard pest repellent system in accordance with an example embodiment.

FIG. 13 is a flowchart illustrating assembly of a double-faced, single layer construct of a corrugated cardboard pest repellent system in accordance with an example embodiment.

FIG. 14 is a flowchart illustrating assembly of a double wall construct of a corrugated cardboard pest repellent system in accordance with an example embodiment.

FIG. 15 is a flowchart illustrating assembly of a triple wall construct of a corrugated cardboard pest repellent system in accordance with an example embodiment.

### DETAILED DESCRIPTION

### A. Overview.

Some of the various embodiments of the present disclosure relate to a corrugated cardboard pest repellent system that can repel or exterminate various pests while minimizing exposure of a handler. Some of the various embodiments of the present disclosure include a first liner 30 comprised of a sheet of a first material and a first medium 20 secured to the first liner 30. The first medium 20 is corrugated such that the first medium 20 comprises a plurality of crests 22 and a plurality of troughs 25. The first medium 20 includes a plurality of crest openings 28 defined between the plurality of crests 22 and a plurality of trough openings 29 defined between the plurality of troughs 25. An adhesive 51 is applied to the first medium 20 and/or the first liner 30 to secure the first liner 30 to the first medium 20. A pest repellent 63 is applied to the first medium 20 to repel pests.

The first liner 30 and the first medium 20 may each be comprised of containerboard. The first liner 30 may be comprised of linerboard and the first medium 20 may be comprised of fluting. The pest repellent 63 may be applied to an underside of each of the plurality of crests 22 of the first medium 20. The pest repellent 63 may be applied within each of the plurality of crest openings 28 of the first medium 20. The pest repellent 63 may be applied across an entire length of each of the plurality of crest openings 28 of the first medium 20. The adhesive 51 may be comprised of glue. The pest repellent 63 may be comprised of a plant-based substance or a scented oil. The adhesive 51 may be applied to select (i.e., some of) or each of the plurality of troughs 25 of the first medium 20.

Another exemplary embodiment may include first and second liners 30 each being comprised of a sheet, and a first medium 20 secured between the first and second liners 30. An adhesive 51 may be utilized to secure the first medium 20 between the first and second liners 30. A pest repellent 63 may be applied to the first medium 20.

Another exemplary embodiment may include a third liner 30 comprised of a sheet, and a second medium 20 secured between the second and third liners 30. A pest repellent 63 may be applied to the second medium 20.

Another exemplary embodiment may include a fourth liner 30 comprised of a sheet, and a third medium 20 secured between the third and fourth liners 30. A pest repellent 63 may be applied to the third medium 20.

### B. Constructs.

As shown throughout the figures, a wide range of constructs 40, 42, 44, 46 may be assembled utilizing the methods and systems described herein. The constructs 40, 42, 44, 46 may be utilized for a wide range of purposes, such as but not limited to storage, transport, packaging, wraps, fillers, and the like.

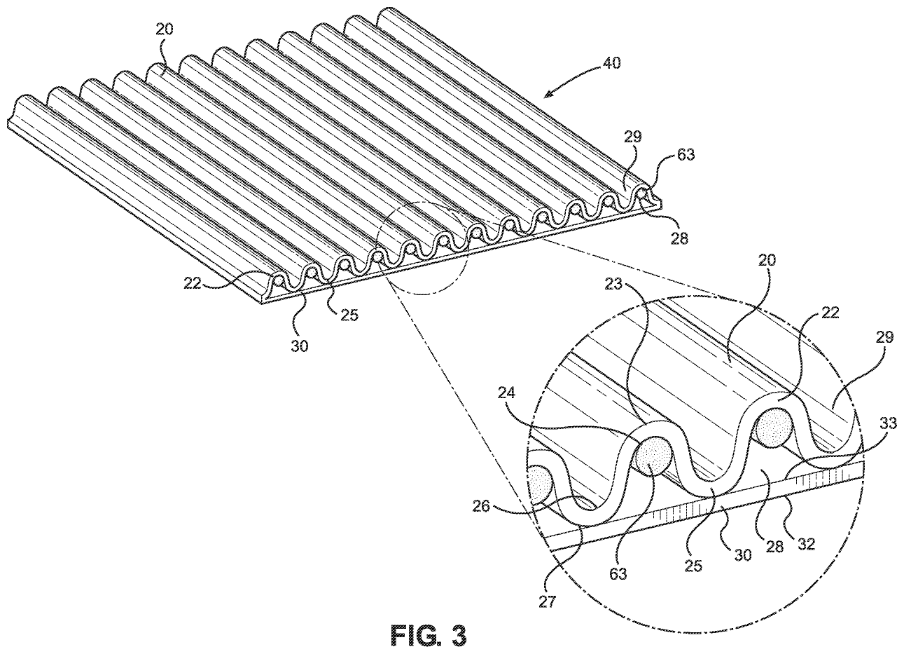

A wide range of corrugated cardboard constructs 40, 42, 44, 46 may be formed to include pest repellent properties using the methods and systems described herein, and the exemplary embodiments shown in the figures should not be construed as limiting in scope. FIG. 3 illustrates an exemplary embodiment of a single face construct 40 which includes a single liner 30 secured to a corrugated medium 20. Such an embodiment may be useful for a wide range of purposes, such as but not limited to use as a corrugated pad which is placed under or between layers of goods to both protect the goods from physical damage during transport and infestation by pests.

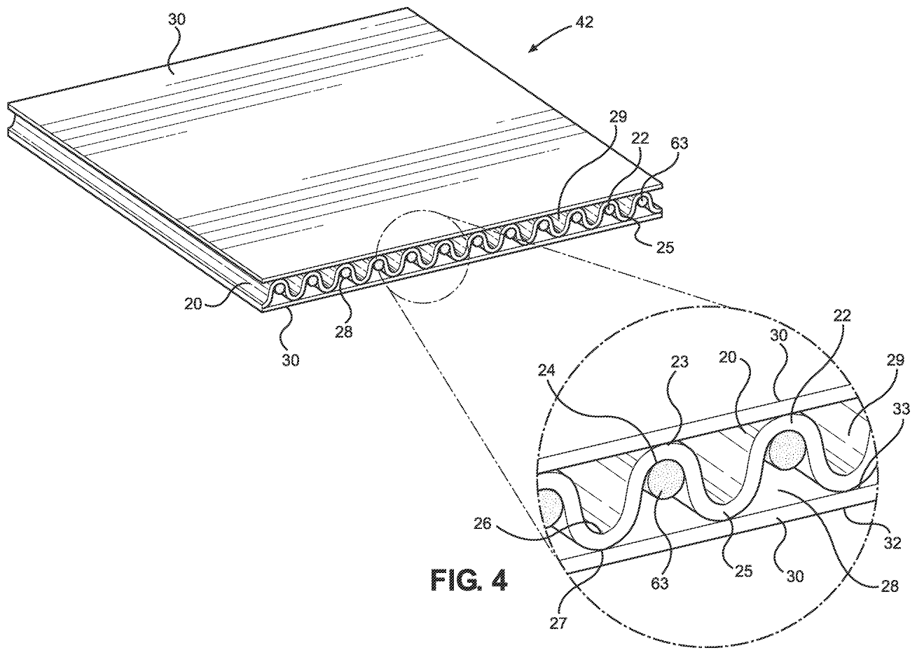

FIG. 4 illustrates an exemplary embodiment of a single wall construct 42 which includes a pair of liners 30, with a first liner 30 secured to a first side of a corrugated medium 20 and a second liner 30 secured to a second side of the corrugated medium 20. As with the single face embodiment, such an embodiment may be useful for a wide range of purposes such as use as a barrier or padding when storing/transporting goods in a container. The single wall construct 42 may also be utilized to form various containers, such as boxes, by interconnecting the single wall construct 42 with other constructs 40, 42, 44, 46 or by folding the single wall construct 42 (in which the single wall construct 42 serves as a blank) to form a container.

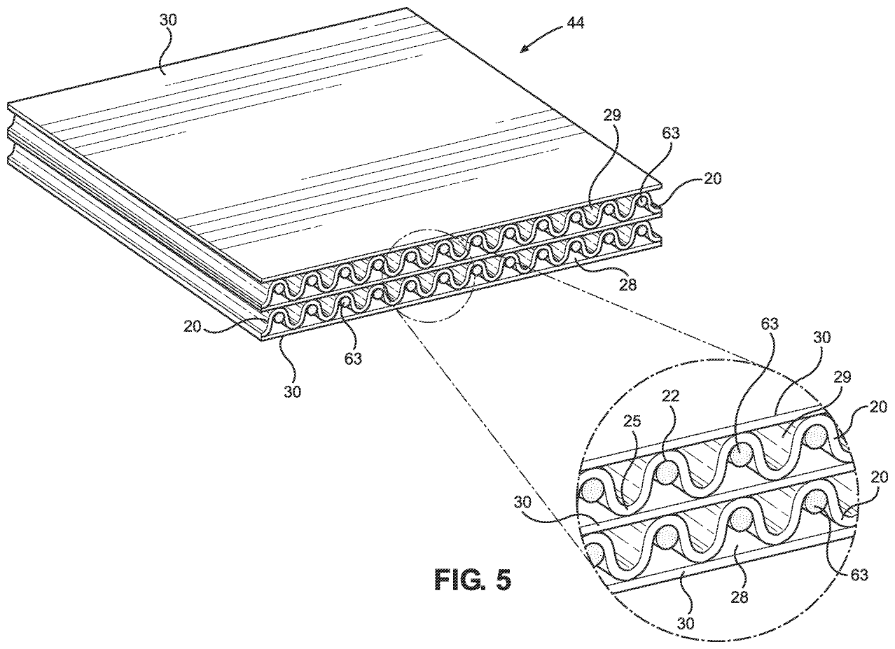

FIG. 5 illustrates an exemplary embodiment of a double wall construct 44 which includes two layers of corrugated medium 20 materials sandwiched between multiple layers of liners 30. More specifically, it can be seen that a first medium 20 is sandwiched between a first liner 30 and a second liner 30, and a second medium 20 is sandwiched between the second liner 30 and a third liner 30. As with the previously-described embodiments, such a double wall construct 44 may be utilized for a wide range of applications, such as but not limited to use in forming a container, barrier, wall, flooring, and the like.

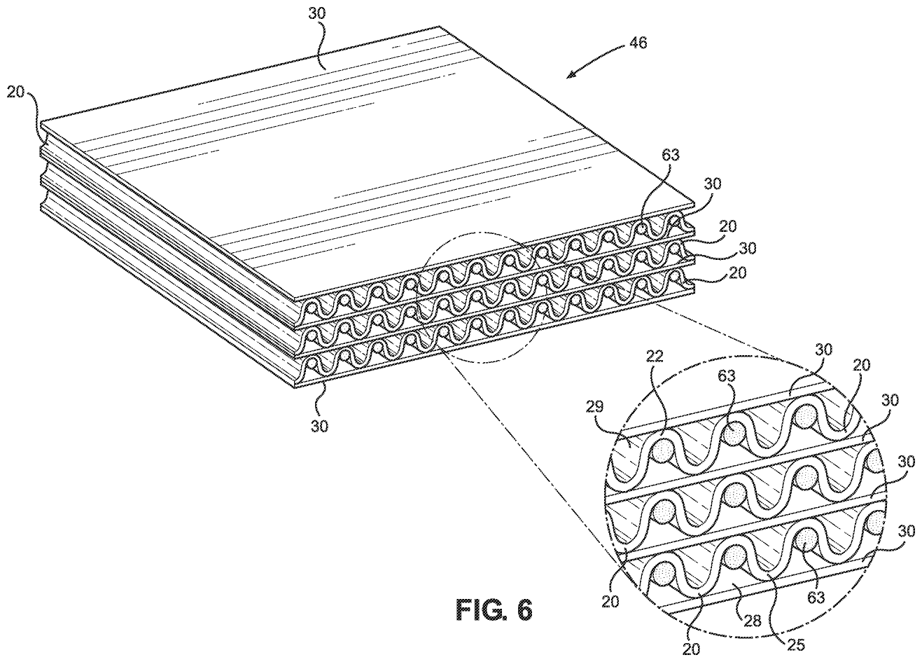

FIG. 6 illustrates an exemplary embodiment of a triple wall construct 46 which includes three layers of corrugated medium 20 materials sandwiched between multiple layers of liners 30. More specifically, it can be seen that a first medium 20 is sandwiched between a first liner 30 and a second liner 30, a second medium 20 is sandwiched between the second liner 30 and a third liner 30, and a third medium is sandwiched between the third liner 30 and a fourth liner 30. Such a triple wall construct 46 may be useful for any other purposes previously described, including but not limited to use in forming barriers or containers.

While the figures only illustrate certain exemplary embodiments of constructs 40, 42, 44, 46, it should be appreciated that a wide range of constructs 40, 42, 44, 46 not shown in the figures could benefit from the methods and systems described herein for repelling pests. For example, additional layers may be utilized (e.g., four layers, five layers, six layers, etc.). In some embodiments, multiple layers of mediums 20 may be positioned adjacent to each other without being separated by a liner 30.

While the methods and systems described herein will generally be utilized to form constructs 40, 42, 44, 46 comprised of corrugated cardboard materials, it should be appreciated that various other materials may be utilized. For example and without limitation, the systems and methods described herein may be utilized to form constructs 40, 42, 44, 46 which are comprised of materials other than cardboard, such as but not limited to paper, plastic, metals, metal alloys, composite materials, and the like.

In an exemplary embodiment, the methods and systems described herein may be utilized with constructs 40, 42, 44, 46 used to form a wide range of different containers such as boxes/cartons for storage or shipping. The constructs 40, 42, 44, 46 may be used to form a corrugated fiberboard carton such as a corrugated fiberboard box. In such embodiments, the constructs 40, 42, 44, 46 may be used as blanks which may be formed into the wide range of different container styles. By way of example and without limitation, the constructs 40, 42, 44, 46 may be used to form regular slotted containers, half slotted containers, overlap slotted containers, full overlap slotted containers, center special slotted containers, center special overlap slotted containers, center special full overlap slotted containers, telescope containers, rigid boxes, self-erecting boxes, one piece folders, five panel folders, trays, and the like. Such containers may include handles, with the constructs 40, 42, 44, 46 also being utilized to form such handles.

In another exemplary embodiment, the methods and systems described herein may be utilized with constructs 40, 42, 44, 46 used to form a wide range of interior forms (e.g., build-ups, dividers, partitions, and other inner packing pieces) that can be used to separate or cushion goods, to strengthen a container, or to fill voids. By way of example and without limitation, the constructs 40, 42, 44, 46 may be used to form pads, tubes, partitions, dividers, inner packing pieces, inner pack forms, and the like.

As a further example, the constructs 40, 42, 44, 46 formed by the methods and systems described herein may comprise multi-layer laminates adapted for use as various structural, interior, and decorative elements in various buildings such as industrial, commercial, and residential buildings. Exemplary laminates may comprise wood, wood fiber, paper, plant fiber, cotton, silicone-glass, synthetic materials, sheet aluminum, or other suitable materials, depending on the application. Structural elements may include framing, joists, flooring, ceilings, wall panels, and the like. Interior elements may include work surfaces, countertops, and the like. Decorative elements may include veneers or other ornamental structures known for their decorative appeal.

As described in more detail herein, the medium(s) 20 of each construct 40, 42, 44, 46 will generally be treated with a pest repellent 63 which is known to repel or exterminate various pests such as insects, arachnids, and the like so as to prevent incursion of such pests on, under, or between the liner(s) 30. The pest repellent 63 is preferably positioned so as to reduce or eliminate the likelihood that the pest repellent 63 will contact the goods being protected or any individuals who handle the constructs 40, 42, 44, 46.

i. Liners.

As shown in the figures, one or more liners 30 may be secured to one or more mediums 20 to form a resulting construct 40, 42, 44, 46. The type of liner 30 utilized may vary in different embodiments. The liner 30 may comprise a flexible, rigid, or semi-rigid material. By way of example and without limitation, the liner 30 may be comprised of containerboard, linerboard, cardboard, paper, plastic, composites, metals, metal alloys, and the like.

Each liner 30 will generally be comprised of a flat sheet of material as shown in the figures. It should be appreciated that the thickness of the liner 30 may vary and thus should not be construed as limited by the exemplary embodiments shown in the figures. The liner 30 may comprise a single sheet of material, or may be comprised of multiple sheets of materials either layered together (to increase thickness) or interconnected to form a larger sheet.

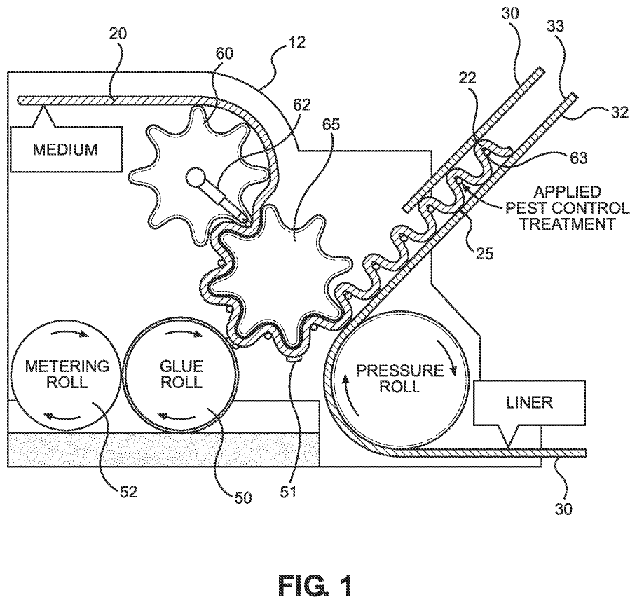

As best shown in FIGS. 1-7, it can be seen that each liner 30 may comprise an outer side 32 and an inner side 33. The outer side 32 of each liner 30 will generally face away from an adjacent medium 20 such as shown in FIG. 3, except in embodiments utilizing multiple layers of mediums 20 such as shown in FIGS. 4-6. In such multi-layer embodiments, the outer side 32 of the liner 30 will face away from a first medium 20 and towards a second medium 20. The inner side 33 of each liner 30 will generally face towards and be secured to an adjacent medium 20 such as shown in FIG. 3. In multi-layered embodiments such as shown in FIGS. 4-6, the inner side 33 of each liner 30 may face towards a second medium 20 and away from a first medium 20.

ii. Mediums.

As shown in the figures, a medium 20 may be secured to one or more liners 30 to form a single-face or multi-faced construct 40, 42, 44, 46. The medium 20 will generally be comprised of a corrugated material such as shown in the figures. However, it should be appreciated that various other shapes of materials may be utilized for the medium 20, such as but not limited to crimped materials, folded materials, bent materials, honeycombed materials, and the like.

The type of material used for the medium 20 may vary in different embodiments, and should not be construed as limited by the exemplary descriptions and figures included herein. By way of example, the medium 20 may be comprised of various paper-based materials such as various types of cardboards, containerboards, or papers. The medium 20 may also be comprised of various plastics, composite materials, metals, metal alloys, and the like. The flexibility of the medium 20 may vary, with some medium 20 materials being flexible and others being rigid or semi-rigid.

In the embodiment best shown in FIGS. 1-7, the medium 20 is illustrated as comprising a fluted material such as paper. A wide range of flute profiles may be utilized to suit different applications, and thus the number of flutes per foot shown in the figures should not be construed as limiting in scope. By way of example and without limitation, industry-standard fluting profiles such as A-Flute, B-Flute, C-Flute, E-Flute, and F-Flute may be utilized, among other non-standard profiles.

In multi-layered constructs 44, 46 such as shown in FIGS. 5 and 6, it should be appreciated that each layer of medium 20 may comprise the same flute profile as shown, or each layer of medium 20 may comprise different flute profiles. For example, a double wall construct 44 such as shown in FIG. 5 may comprise an A-Flute profile for the first medium 20 and a C-Flute profile for the second medium 20. A wide range of other combinations may also be utilized.

In the exemplary embodiments shown in the figures, it can be seen that the medium 20 is comprised of a fluted corrugated sheet of material (e.g., kraft containerboard or other paperboard materials). In the figures, it can be seen that each medium 20 is fluted so as to include a plurality of crests 22 (e.g., the top of each fluted “wave”) and a plurality of troughs 25 (e.g., the bottom of each fluted “wave”). While the figures illustrate fluting similar to a sine-wave, it should be appreciated that different, non-sinusoidal shapes may be utilized such as but not limited to squares (e.g., square wave), triangles (e.g., sawtooth wave), and the like.

As best shown in FIGS. 1-7, each of the crests 22 of the fluted medium 20 includes an outer side 23 and an inner side 24. The outer side 23 of each crest 22 is comprised of the outer-facing side of the crest 22 (e.g., the side of the crest 22 oriented away from the trough 25). The inner side 24 of each crest 22 is comprised of the inner-facing side of the crest 22 (e.g., the side of the crest 22 oriented towards the trough 25). The outer side 23 of each crest 22 may be exposed in a single face construct 40 such as shown in FIG. 3, or may be secured to a liner 30 in a multi-walled or multi-layered construct 42, 44, 46 such as shown in FIGS. 4-6.

Continuing to reference FIGS. 1-7, it can be seen that each of the troughs 25 of the fluted medium 20 includes an outer side 26 and an inner side 27. The outer side 26 of each trough 25 is comprised of the outer-facing side of the trough 25 (e.g., the side of the trough 25 oriented towards the crest 22). The inner side 27 of each trough 25 is comprised of the inner-facing side of the trough 25 (e.g., the side of the trough 25 oriented away from the crest 22). Generally, the inner side 27 of each trough 25 will be secured to a liner 30, such as by an adhesive 51 as discussed herein.

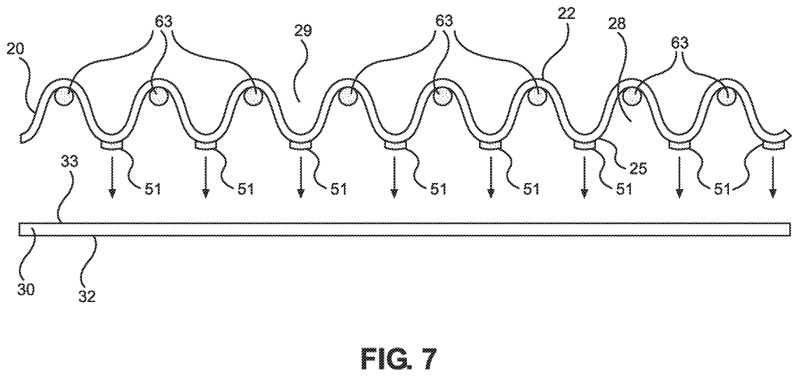

As shown throughout the figures, each fluted medium 20 includes openings 28, 29 defined between the flutes. As shown in FIG. 7, crest openings 28 may be comprised of elongated openings defined between the respective crests 22 of adjacent waves. The crest openings 28 are generally upward-facing as shown in the figures. Trough openings 29 may be comprised of elongated openings defined between the respective troughs 25 of adjacent waves. The trough openings 29 are generally downward-facing as shown in the figures. As described in more detail herein, each construct 40, 42, 44, 46 may include a pest repellent 63 applied within one or more of the trough openings 29.

### C. Adhesive.

As shown throughout the figures, a medium 20 may be secured to one or more liners 30 by an adhesive 51. The adhesive 51 may be applied to the medium 20 such as shown in FIG. 7. In some embodiments, the adhesive 51 may instead or additionally be applied to the liner 30. The location on the medium and/or liner 20, 30 at which the adhesive 51 is applied may vary in different embodiments.

In the exemplary embodiment shown in FIG. 3 illustrating a single face construct 40, it can be seen that the adhesive 51 may be applied to the troughs 25 of the medium 20. In some embodiments, the adhesive 51 may be applied to each trough 25 of the medium 20. In other embodiments, the adhesive 51 may instead be applied to only some of the troughs 25 of each medium 20 (e.g., every other or every third trough 25). As shown in FIG. 7, the adhesive 51 may be applied to the inner side 27, which faces the liner 30, of each trough 25 of the medium 20.

It should also be appreciated that, in some embodiments, the adhesive 51 may be additionally or alternatively be applied to the crests 22 of the medium 20. By way of example, in single- or multi-wall constructs 42, 44, 46 such as shown in FIGS. 3-6, the adhesive 51 may be applied to both the crests 22 and the troughs 25 of the medium 20. More specifically, the adhesive 51 may be applied to the outer side 23, which faces the liner 30, of each crest 22 of the medium 20.

In some embodiments, the adhesive 51 may be applied to each crest 22 of the medium 20. In other embodiments, the adhesive 51 may instead be applied to only some of the crests 22 of each medium 20 (e.g., every other or every third crest 22).

The manner by which the adhesive 51 is applied to the medium 20 and/or the liner 30 may vary in different embodiments. FIG. 1 illustrates a construct machine 12 which includes an adhesive applicator 50 comprised of a roller having the adhesive 51 positioned along the outer circumference of the roller. An adjacent gear 65 rolls along the adhesive applicator 50 such that the adhesive 51 is applied to the trough 25 of the medium 20 as it is being corrugated.

In alternate embodiments, the adhesive 51 may be applied using various other methods. For example, the adhesive 51 may be painted directly onto the medium 20. As a further non-limiting example, the adhesive 51 may be sprayed onto the medium 20. In some embodiments, the medium 20 itself may be constructed with the adhesive 51 such that adhesive 51 does not need to be separately applied.

Various types of adhesives 51 known in the art to secure paper-based materials together may be utilized. In some embodiments, the adhesive 51 itself may include pest repellent properties (e.g., a pest repellent adhesive). The type of adhesive 51 utilized may vary among different embodiments depending on the requirements of the particular application and the desired characteristics of the adhesive, including porosity, viscosity, plasticity, bond strength, and elasticity. The adhesive 51 may comprise a liquid (e.g., glue) in some embodiments. In other embodiments, the adhesive 51 may comprise a solid (e.g., tape).

Depending on the embodiment, the adhesive 51 may be non-reactive, and comprise, e.g., drying adhesives, contact adhesives, pressure-sensitive adhesives, and hot adhesives. In other embodiments, the adhesive 51 may be reactive, and comprise, e.g., anaerobic adhesives, multi-part adhesives, pre-mixed adhesives, one-part adhesives, epoxies, and resins. In addition, the adhesive 51 may be natural or synthetic.

### D. Pest Repellent.

Generally, a pest repellent 63 is applied to the medium 20 of the construct 40, 42, 44, 46 either prior to, during, or after securing one or more liners 30 to the medium 20 to form the construct 40, 42, 44, 46. The pest repellent 63 will preferably be comprised of a substance known to deter (e.g., by odor) or exterminate various pests such as insects, arachnids, rodents, or any other living organism which is deemed a threat or a nuisance. The pest repellent 63 may be positioned in various crevices or openings within the construct 40, 42, 44, 46 so as to both prevent incursion by various pests and reduce or eliminate the risk of exposure to one handling the construct 40, 42, 44, 46.

Various types of pest repellents 63 known in the art to repel or exterminate various pests may be utilized. Such pests may include, among other things, insects (e.g. ants, flies, susa etc.), worms, rodents (e.g. mice, rats, etc.), arachnids (e.g., spiders), birds and/or other types of organisms. A wide range of different pest repellents 63 may be utilized, including solids and liquids including, but not limited to, oils or other substances/chemicals. The pest repellent 63 may be natural (e.g., plant-based), synthetic, or semi-synthetic. The pest repellent 63 may be scented, such as by being comprised of a scented oil.

In an exemplary embodiment, the pest repellent 63 may comprise one or more plant-based essential oils. Such oils include, e.g., cedarwood oil, geranium oil, sunflower oil, almond oil, rosemary oil, lemongrass oil, citronella oil, peppermint oil, thyme oil, and Canada balsam oil. U.S. Pat. No. 6,337,081, the entire disclosure of which, except for any definitions, disclaimers, disavowals, and inconsistencies, is incorporated herein by reference, identifies various oil-based pest repellents 63 that may be utilized in connection with the systems and methods described herein.

In another exemplary embodiment, the pest repellent 63 may comprise isolated or synthesized constituents of plant-based essential oils, including aromatic compounds. Such aromatic compounds may include, without limitation, terpenes, e.g., cedrol, α-cedrene, β-cedrene, thujopsene, limonene, pulegone, geraniol, geranial, neral, citronellol, citronellal, citronellyl acetate, menthone, menthol, isomenthone, limonene, piperitone, α-phillandrene, β-phillandrene, β-myrcene, α-pinene, ρ-pinene, sabinene, camphene, cineole, camphor, α-terpineol, borneol, α-Citral, ρ-Citral, Nerol Geraniol, Citronellal, Terpinolene, Geranyl acetate, Myrecene, Terpinol and Methylheptenone, and phenols, e.g., luteolin, isoorientin 2′-O-rhamnoside, quercetin, kaempferol and apiginin. Aromatic compounds contemplated may include all enantiomers, isomers and racemic mixtures of same.

Other oils, chemicals, or substances having pest repellent properties not mentioned here but known in the art may be used. In addition, the pest repellent 63 may further comprise various additives as dictated by the particular application. For example, a colored dye may be added to the pest repellent 63 to ensure a visible residue is created upon application. Other additives that affect adhesive characteristics may also be utilized.

As yet another example, the pest repellent 63 may comprise plant-derived substances such as picaridin (also referred to as icaridin), balsam fir oil, various plant fibers, lemongrass oil, peppermint oil, thyme oil, corn cob oil, almond oil, sunflower oil, rosemary oil, citronella oil, cedarwood oil, geranium oil, geraniol oil, mixtures thereof, and the like.

### E. Operation/Assembly of Preferred Embodiment.

The manner by which the constructs 40, 42, 44, 46 are assembled may vary widely in different embodiments to suit different applications. Generally, one or more mediums 20 will be secured to one or more liners 30. A pest repellent 63 is applied to one or more mediums 20, which acts to repel pests and/or prevent incursion of pests between the liners 30 or to exterminate any such pests.

The manner and timing of application of the pest repellent 63 to the medium 20 may vary in different embodiments as described herein. The pest repellent 63 may be applied to the medium 20 prior to the medium 20 being secured to a liner 30. The pest repellent 63 may be applied to the medium 20 as the medium 20 is being secured to the liner 30. The pest repellent 63 may be applied to the medium 20 after the medium 20 has been secured to the liner 30. In some embodiments, the medium 20 itself may include pest repellent properties (e.g., the material used to form the medium 20 may have previously been infused with or exposed to the pest repellent 63).

The manner of securing the medium 20 to the liner 30 may also vary in different embodiments. In some embodiments, the adhesive 51 may be applied directly to the medium 20, and then the liner 30 secured to the medium 20. In other embodiments, the adhesive 51 may be applied to the liner 30, and then the medium 20 secured to the liner 30. In other embodiments, adhesive 51 may be applied to both the medium 20 and the liner 30.

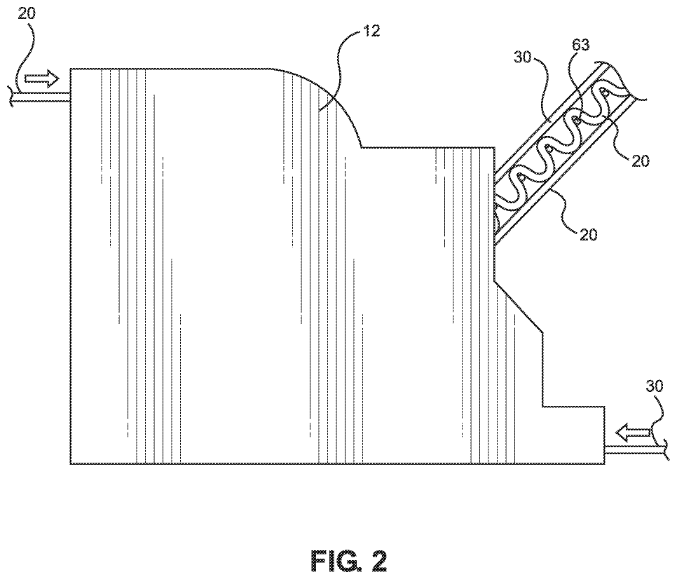

FIGS. 1 and 2 illustrate an exemplary assembly machine 12 for use in forming a construct 40, 42, 44, 46 in which a pest repellent 63 is applied to the medium 20 during formation of the construct 40, 42, 44, 46. As shown in FIG. 1, the assembly machine 12 may comprise an inlet for receiving the medium 20. The medium 20 is passed between a pair of gears 60, 65 which crimp or otherwise alter the flat medium 20 into a fluted configuration. The gears 60, 65 may thus have interlocking projections such as shown in the figures to create the fluting of the medium 20 as it passes between the gears 60, 65.

Continuing to reference FIG. 1, it can be seen that the medium 20 is passed between a first gear 60 and a second gear 65. The shape of the projections on the respective gears 60, 65 will generally determine the shape of the fluting applied to the medium 20. It should be appreciated that the shape of the projections shown in FIG. 1 is merely for exemplary purposes, and thus other shapes may be utilized. For example, the gears 60, 65 may in some embodiments include square-shaped projections to form square-shaped fluting, or triangular-shaped projections to form triangular-shaped fluting.

As shown in FIG. 1, the first gear 60 may include a repellent applicator 62 which is adapted to apply the pest repellent 63 to the medium 20. It should be appreciated, however, that the repellent applicator 62 in some embodiments may instead be connected to the second gear 65.

The repellent applicator 62 may comprise an injector such as shown in the figures, or may comprise any other device capable of applying the pest repellent 63 to the medium 20, such as but not limited to various spray nozzles, brushes, and the like. The repellent applicator 62 may be fluidly connected (directly or indirectly) to a reservoir of the pest repellent 63, or may be manually refilled as-needed. The repellent applicator 62 may be fixed (e.g., not rotate with the gear 60) so as to apply the pest repellent 63 underneath each crest 22 of the medium 20, or may rotate with the gear 60 so as to apply the pest repellent 63 only to some of the crests 22 of the medium 20 (e.g., every third crest).

Continuing to reference FIG. 1, it can be seen that an adhesive applicator 50 may be positioned adjacent to the second gear 65 so as to apply the adhesive 51 to each trough 25 of the medium 20. The adhesive applicator 50 may comprise a glue roll as shown in FIG. 1, or may comprise various other devices known to apply a substance, such as brushes, injectors, spray nozzles, and the like. In the embodiment shown in the figures, the adhesive applicator 50 comprises a roller which continuously rolls along a reservoir of adhesive 51 and then applies the adhesive 51 to the fluted medium 20 after the medium 20 has passed between the first and second gears 60, 65. A metering roll 52 may be positioned adjacent to the adhesive applicator 50, with the metering roll 52 functioning to meter movement of the adhesive applicator 50.

After the adhesive 51 has been applied to the medium 20 by the adhesive applicator 50 and the pest repellent 63 has been applied to the medium 20 by the repellent applicator 62, the medium 20 continues to be conveyed by the second gear 65 to be secured to the liner 30. In the embodiment shown in FIG. 1, the liner 30 is fed through an inlet of the assembly machine 12 and wound around a pressure roll 54. The pressure roll 54 is positioned adjacent to the second gear 65 such that the medium 20 is pressed against the liner 30, with the adhesive 51 securing the medium 20 to the liner 30. The construct 40, 42, 44, 46 is then fed through an outlet of the assembly machine 12 to be retrieved for further use.

The same steps may be repeated to add different layers of medium 20 and/or liner 30 as-needed to form various types of constructs 40, 42, 44, 46. In some embodiments, multiple assembly machines 12 may be utilized in series to add different layers. In other embodiments, the same assembly machine 12 may be utilized repeatedly to add layers as-needed. Some embodiments of the assembly machine 12 may comprise multiple stages, such as by utilizing additional gears 60, 65, rolls 52, 54, applicators 50, 62, and the like such that a single assembly machine 12 may be utilized to form multi-layered constructs 42, 44, 46.

FIG. 3 illustrates a single face construct 40 including a medium 20 secured on only one side of a liner 30. Such a configuration allows for more flexibility such that the single face construct 40 may be wrapped around various goods. The single face construct 40 may be formed using the assembly machine 12 discussed previously, or by any other number of manners. Such a single face construct 40 may be utilized for a wide range of purposes, including but not limited to use as padding or a barrier between goods, or as a mat to be placed underneath goods.

As shown in FIG. 3, the pest repellent 63 is applied to the underside of select or each crest 22 of the medium 20. More specifically, the pest repellent 63 is shown as being applied to the inner side 24 of select or each crest 22, within each crest opening 28. The pest repellent 63 may extend for the entire elongated length of the crest opening 28, or may be positioned just at the inlets (on both sides) of select or each crest opening 28.

The pest repellent 63 may thus be applied only at or near the entrances to each crest opening 28 so as to repel and/or prevent incursion by various pests, or to exterminate any curious pests attempting to enter the crest opening 28, or to permit the scent of the repellent to be emitted from the crest opening 28 without risk of contamination or exposure by handlers. However, in some embodiments, the pest repellent 63 may be applied throughout the crest opening 28. While the figures illustrate that the pest repellent 63 is a cylindrical shape, it should be appreciated that, in some embodiments, the pest repellent 63 may be a liquid that is dissolved or infused within the medium 20 and thus not separately visible. In some embodiments, as previously described, the pest repellent 63 may be dyed such that the medium 20 is itself dyed to indicate the presence of the pest repellent 63.

FIG. 4 illustrates a single wall construct 42 including a medium 20 having a pair of liners 30 secured to both sides of the medium 20. Such a configuration is more rigid than the single face construct 40 previously discussed. The single wall construct 42 may be assembled using one or more assembly machines 12, or by various other methods as discussed herein.

In the single wall construct 42, the pest repellent 63 is similarly applied to the medium 20 and, more specifically, may be applied on the underside of each (or some of) the crests 22 of the medium 20. Such an embodiment may be utilized as a blank to construct various containers as previously discussed, or may also be utilized as a padding, insert, or barrier.

FIG. 5 illustrates a double wall construct 44 including a pair of layers of medium 20, each having a pair of liners 30 secured to both sides. Such a configuration is generally rigid or semi-rigid. The double wall construct 44 may be assembled using one or more assembly machines 12, or by various other methods as discussed herein.

In the double wall construct 44, it can be seen that a first medium 20 is sandwiched between first and second liners 30. A second medium 20 is stacked on top of the second liner 30, and sandwiched between second and third liners 30. The pest repellent 63 may be applied to only one layer of medium 20 or two both layers of medium 20 as shown in the figures. In this manner, both layers of medium 20 may be protected from pest incursion.

FIG. 6 illustrates a triple wall construct 46 including three layers of medium 20, each having a pair of liners 30 secured to both sides. Such a configuration is generally rigid or semi-rigid. The triple wall construct 46 may be assembled using one or more assembly machines 12, or by various other methods as discussed herein.

In the triple wall construct 46, it can be seen that a first medium 20 is sandwiched between first and second liners 30. A second medium 20 is stacked on top of the second liner 30, and sandwiched between second and third liners 30. A third medium 20 is stacked on top of the third liner 30, and sandwiched between third and fourth liners 30.

Both the double and triple wall constructs 44, 46 may be utilized as a blank to construct various containers as previously discussed, or may also be utilized as a padding, insert, or barrier. Additional layers may be added as-needed to suit different applications. It should be appreciated that, in some embodiments, not all layers of the medium 20 may be treated by the pest repellent 63. In other embodiments, however, each layer of the medium 20 may be treated by the pest repellent 63.

FIG. 7 illustrates an exemplary method of securing a medium 20 to a liner 30. In such an embodiment, the pest repellent 63 may be applied underneath each crest 22 of the medium 20. More specifically, it can be seen that pest repellent 63 has been applied to the inner side 24 of each crest 22 at the entrance to each crest opening 28 of the medium 20. Adhesive 51 may be applied underneath each trough 25 of the medium 20. More specifically, it can be seen that adhesive 51 has been applied to the inner side 27 of each trough 25 of the medium 20. The medium 20 may then be secured to the liner 30. Such steps may be repeated as necessary to add multiple layers of mediums 20 and/or liners 30.

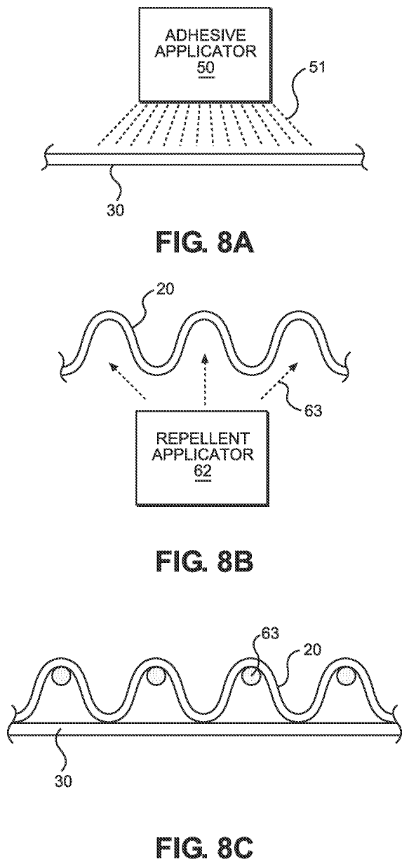

FIGS. 8A, 8B, and 8C illustrate an exemplary method of securing a medium 20 to a liner 30. FIG. 8A illustrates use of an adhesive applicator 50, which may be comprised of a spray nozzle for distributing the adhesive 51 as a spray, to the outer side 32 of the liner 30. FIG. 8B illustrates a repellent applicator 62 being utilized to apply a pest repellent 63 within each crest opening 28 of the medium 20. FIG. 8C illustrates that the liner 30 has been secured to the underside of the medium 20, with the pest repellent 63 being applied to the medium 20 and the adhesive 51 securing the medium 20 to the liner 30.

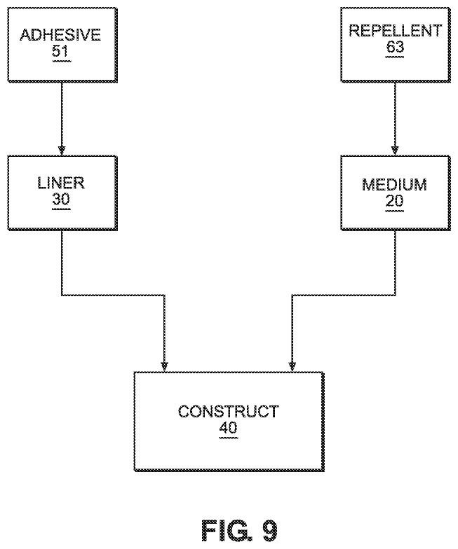

FIG. 9 is a block diagram illustrating an exemplary system for forming various constructs 40, 42, 44, 46 in which a medium 20 has been treated with a pest repellent 63 and secured to a liner 30. As shown in FIG. 9, the adhesive 51 may be applied to the liner 30 and the pest repellent 63 may be applied to the medium 20. However, in some embodiments, the adhesive 51 may also or alternatively be applied to the medium 20. In either case, the construct 40, 42, 44, 46 is formed by securing the pest repellent 63 treated medium 20 to the liner 30.

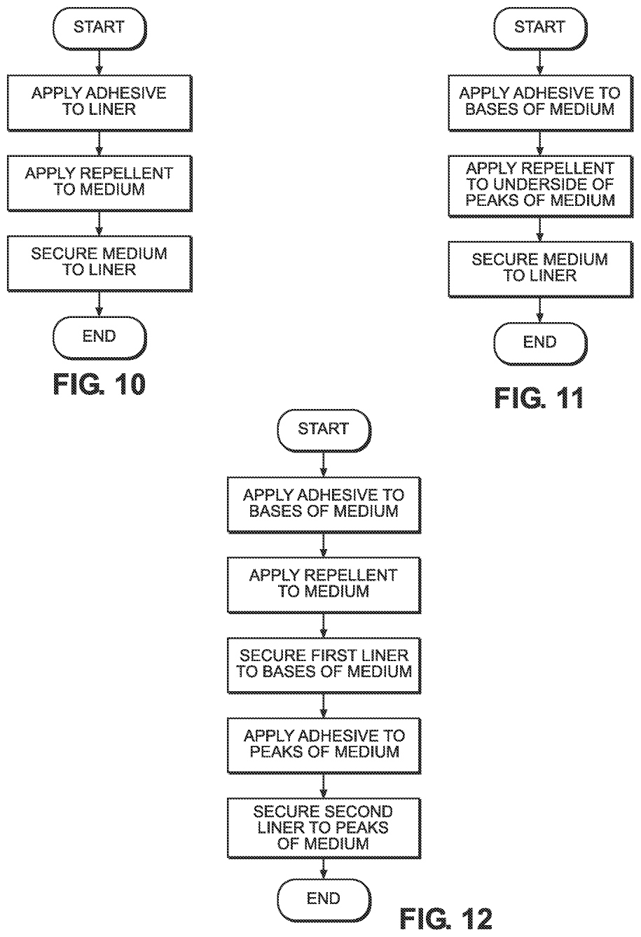

FIG. 10 is a flowchart illustrating one exemplary method of forming a construct 40, 42, 44, 46. As shown in FIG. 10, adhesive 51 may be applied to the liner 30, such as by an adhesive applicator 50. Pest repellent 63 may be applied to the medium 20, such as by a repellent applicator 62. The medium 20 may then be secured to the liner 30.

FIG. 11 is a flowchart illustrating another exemplary method of forming a construct 40, 42, 44, 46. As shown in FIG. 11, adhesive 51 may be applied to the troughs 25 (i.e., bases) of the medium 20. Pest repellent 63 may be applied to the underside of the crests 22 (i.e., peaks) of the medium 20. The medium 20 may then be secured to the liner 30.

FIG. 12 is a flowchart illustrating an exemplary method of forming a single wall construct 42 such as is shown in FIG. 4. As shown in FIG. 12, an adhesive 51 may be applied to the troughs 25 of a medium 20. Similarly, the medium 20 may be treated with the pest repellent 63. A first liner 30 may then be secured to the troughs 25 of the medium 20. An adhesive 51 may be applied to the crests 22 of the medium 20, and a second liner 30 may then be secured to the crests 22 of the medium 20 to form the single wall construct 42.

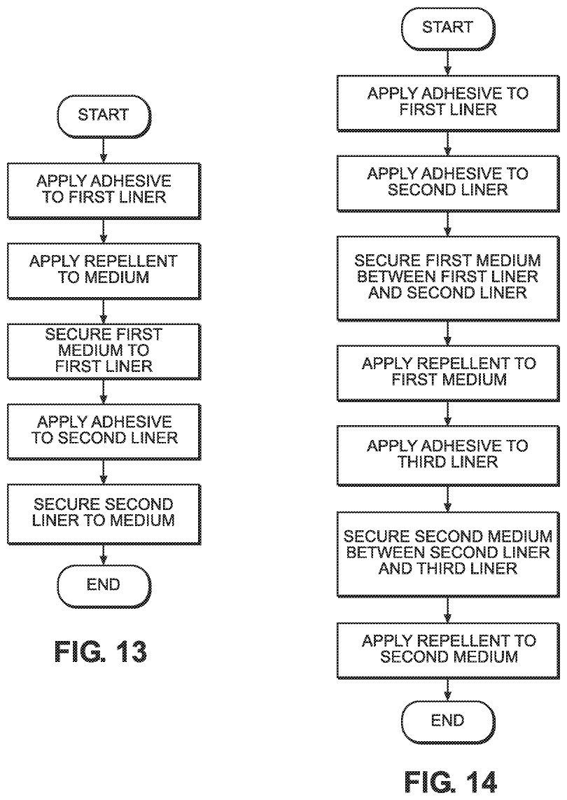

FIG. 13 is a flowchart illustrating another exemplary method of forming a single wall construct 42 such as is shown in FIG. 4. As shown in FIG. 13, an adhesive 51 is applied to a first liner 30, a pest repellent 63 is applied to a medium 20, and the medium 20 is secured to the first liner 30. An adhesive 51 may also be applied to a second liner 30, with the second liner 30 being secured to the medium 20 to form the single wall construct 42.

FIG. 14 is a flowchart illustrating an exemplary method of forming a double wall construct 44 such as is shown in FIG. 5. As shown in FIG. 14, an adhesive 51 is applied to both first and second liners 30, with a first medium 20 being secured between the first and second liners 30. Pest repellent 63 is applied to the first medium 20 either prior to, during, or after it has been secured between the first and second liners 30. An adhesive 51 is applied to a third liner 30, and a second medium 20 is secured between the second and third liners 30. Pest repellent 63 is applied to the second medium 20 either prior to, during, or after it has been secured between the second and third liners 30, thus forming the double wall construct 44.

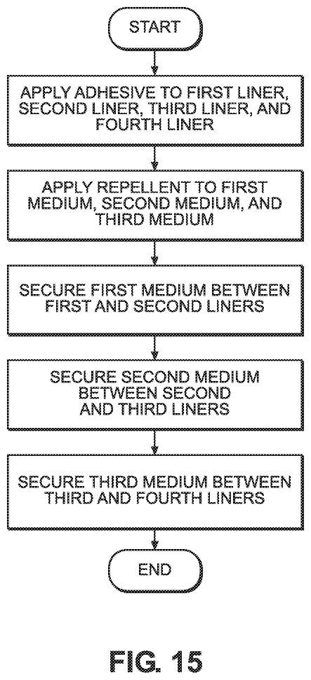

FIG. 15 is a flowchart illustrating an exemplary method of forming a triple wall construct 46 such as is shown in FIG. 6. As shown in FIG. 15, adhesive 51 may be applied to first, second, third, and fourth liners 30 and pest repellent 63 may be applied to first, second, and third mediums 20. The first medium 20 is secured between the first and second liners 30, the second medium 20 is secured between the second and third liners 30, and the third medium 20 is secured between the third and fourth liners 30.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

1. A corrugated cardboard packaging pest repellent system, comprising:
a corrugated cardboard container construct within which one or more goods are packaged, the corrugated cardboard container construct comprising:
a first packaging liner, wherein the first packaging liner is comprised of a sheet of a first material;
a first packaging medium secured to the first packaging liner, wherein the first packaging medium is comprised of a second material, wherein the first packaging medium is corrugated such that the first packaging medium comprises a plurality of crests and a plurality of troughs, wherein the first packaging medium includes a plurality of crest openings defined between the plurality of crests and a plurality of trough openings defined between the plurality of troughs;
an adhesive, wherein the adhesive is adapted to secure the first packaging liner to the first packaging medium; and
a pest repellent, wherein the pest repellent is present on an underside of at least a portion of the plurality of crests of the first packaging medium and wherein the position of the pest repellant on the underside of at least the portion of the plurality of crests prevents contact between the pest repellant and the one or more goods.

2. The corrugated cardboard packaging pest repellent system of claim 1, wherein the first material and the second material are each comprised of containerboard.

3. The corrugated cardboard packaging pest repellent system of claim 1, wherein the first material is comprised of linerboard and the second material is comprised of fluting.

4. (canceled)

5. The corrugated cardboard packaging pest repellent system of claim 1, wherein the pest repellent is present on each of the plurality of crest openings of the first packaging medium.

6. The corrugated cardboard packaging pest repellent system of claim 5, wherein the pest repellent is present across an entire length of each of the plurality of crest openings of the first packaging medium.

7. The corrugated cardboard packaging pest repellent system of claim 1, wherein the adhesive is comprised of glue.

8. The corrugated cardboard packaging pest repellent system of claim 1, wherein the pest repellent is comprised of a plant-based substance.

9. The corrugated cardboard packaging pest repellent system of claim 1, wherein the pest repellent is comprised of a scented oil.

10. The corrugated cardboard packaging pest repellent system of claim 1, wherein the adhesive is present on each of the plurality of troughs of the first packaging medium.

11. A method of assembling the corrugated cardboard packaging pest repellent system of claim 1, comprising the steps of:
corrugating the first packaging medium to form the plurality of crests;
applying the pest repellent to an underside of each of the plurality of crests of the first packaging medium;
applying the adhesive to one or more of the plurality of crests of the first packaging medium; and
securing the first packaging medium to the first packaging liner.

12. A corrugated cardboard packaging pest repellent system, comprising:
a corrugated cardboard container construct within which one or more goods are packaged, the corrugated cardboard container construct comprising:
a first packaging liner comprised of a first sheet;
a second packaging liner comprised of a second sheet;
a first packaging medium secured between the first packaging liner and the second packaging liner, wherein the first packaging medium is corrugated such that the first packaging medium comprises a first plurality of crests and a first plurality of troughs, wherein the first packaging medium includes a first plurality of crest openings defined between the first plurality of crests and a first plurality of trough openings defined between the first plurality of troughs;
an adhesive, wherein the adhesive is adapted to secure the first packaging medium between the first packaging liner and the second packaging liner; and
a pest repellent, wherein the pest repellent is present on an underside of at least a portion of the plurality of crests of the first packaging medium and wherein the position of the pest repellant on the underside of at least the portion of the plurality of crests prevents contact between the pest repellant and the one or more goods.

13. A method of assembling the corrugated cardboard packaging pest repellent system of claim 12, comprising the steps of:
corrugating the first packaging medium to form the first plurality of crests;
applying the pest repellent to an underside of each of the first plurality of crests of the first packaging medium;
applying the adhesive to the first packaging liner and the second packaging liner; and
securing the first packaging medium between the first packaging liner and the second packaging liner.

14. The corrugated cardboard packaging pest repellent system of claim 12, further comprising:
a third packaging liner comprised of a third sheet; and
a second packaging medium secured between the second packaging liner and the third packaging liner, wherein the pest repellent is present on the second packaging medium.

15. The corrugated cardboard packaging pest repellent system of claim 14, wherein the second packaging medium is corrugated such that the second packaging medium comprises a second plurality of crests and a second plurality of crest openings defined between the second plurality of crests, and wherein the pest repellent is present within each of the second plurality of crest openings of the second packaging medium.

16. A method of assembling the corrugated cardboard packaging pest repellent system of claim 15, comprising the steps of:
corrugating the first packaging medium to form the first plurality of crests;
applying the pest repellent to an underside of each of the first plurality of crests of the first packaging medium;
corrugating the second packaging medium to form the second plurality of crests;
applying the pest repellent to an underside of each of the second plurality of crests of the second packaging medium;
applying the adhesive to the first packaging liner, the second packaging liner, and the third packaging liner;
securing the first packaging medium between the first packaging liner and the second packaging liner; and
securing the second packaging medium between the second packaging liner and the third packaging liner.

17. The corrugated cardboard packaging pest repellent system of claim 14, further comprising:
a fourth packaging liner comprised of a fourth sheet; and
a third packaging medium secured between the third packaging liner and the fourth packaging liner, wherein the pest repellent is present on the third packaging medium.

18. The corrugated cardboard packaging pest repellent system of claim 17, wherein the third packaging medium is corrugated such that the third packaging medium comprises a third plurality of crests and a third plurality of crest openings defined between the third plurality of crests, and wherein the pest repellent is present within each of the third plurality of crest openings of the third packaging medium.

19. A method of assembling the corrugated cardboard packaging pest repellent system of claim 18, comprising the steps of:
corrugating the first packaging medium to form the first plurality of crests;
applying the pest repellent to an underside of each of the first plurality of crests of the first packaging medium;
corrugating the second packaging medium to form a second plurality of crests of the second packaging medium;
applying the pest repellent to an underside of each of the second plurality of crests;
corrugating the third packaging medium to form the third plurality of crests;
applying the pest repellent to an underside of each of the third plurality of crests of the third packaging medium;
applying the adhesive to the first packaging liner, the second packaging liner, the third packaging liner, and the fourth packaging liner;
securing the first packaging medium between the first packaging liner and the second packaging liner;
securing the second packaging medium between the second packaging liner and the third packaging liner; and
securing the third packaging medium between the third packaging liner and the fourth packaging liner.

20. A corrugated cardboard packaging pest repellent system, comprising:
a corrugated cardboard container construct within which one or more goods are packaged, the corrugated cardboard container construct comprising:
a first packaging liner comprised of a first sheet of linerboard;
a second packaging liner comprised of a second sheet of linerboard;
a first packaging medium secured between the first packaging liner and the second packaging liner, wherein the first packaging medium is comprised of fluting, wherein the first packaging medium is corrugated such that the first packaging medium comprises a first plurality of crests and a first plurality of troughs, wherein the first packaging medium includes a first plurality of crest openings defined between the first plurality of crests and a first plurality of trough openings defined between the first plurality of troughs;
an adhesive present on each of the first plurality of crests of the first packaging medium and each of the first plurality of troughs of the first packaging medium, wherein the adhesive is adapted to secure each of the first plurality of troughs of the first medium to the first packaging liner, and wherein the adhesive is adapted to secure each of the first plurality of crests of the first packaging medium to the second packaging liner; and
a pest repellent, wherein the pest repellent is present on an underside of at least a portion of the first plurality of crests of the first packaging medium and wherein the position of the pest repellant on the underside of at least the portion of the plurality of crests prevents contact between the pest repellant and the one or more goods.

21. The corrugated cardboard packaging pest repellent system of claim 1, wherein the one or more goods comprise at least one of: a food, a paper good, or a plant material.
